(19) United States
(12) Patent Application Publication
(10) Pub. No.: US 2023/0144098 A1
(43) Pub. Date: May 11, 2023

(54) FREQUENCY DOMAIN NEURAL NETWORKS FOR DATA-DRIVEN SIMULATIONS

(71) Applicant: Microsoft Technology Licensing, LLC, Redmond, WA (US)

(72) Inventor: Philipp Andre WITTE, Seattle, WA (US)

(73) Assignee: Microsoft Technology Licensing, LLC, Redmond, WA (US)

(21) Appl. No.: 17/688,586

(22) Filed: Mar. 7, 2022

Related U.S. Application Data
(60) Provisional application No. 63/276,754, filed on Nov. 8, 2021.

(51) Int. Cl. G06F 30/27; G06F 30/28

(52) U.S. Cl. CPC G06F 30/27; G06F 30/28; G06F 2111/10

(57) ABSTRACT

In a numerical simulation, input data expressed in at least a first domain is received. The input data is decomposed into at least i) low-pass filtered data that captures a low-pass filtered version of the input data in the at least the first domain and ii) high-pass filtered data that captures a high-pass filtered version of the input data in the at least the first domain. The low-pass filtered data is transformed to frequency domain, and weights are applied to the low-pass filtered data in the frequency domain to generate weighted low-pass filtered data in the frequency domain. The weighted low-pass filtered data is transformed from the frequency domain to the at least the first domain, and output data for the numerical simulation is composed based on at least the weighted low-pass filtered data in the at least the first domain.

### CROSS-REFERENCE TO RELATED APPLICATIONS

This application claims the benefit of priority to U.S. Provisional Application No. 63/276,754, entitled “Fourier Neural Operator Networks with Sub-Sampled Non-Linear Transformations,” filed Nov. 8, 2021, the entire disclosure of which is hereby incorporated by reference herein in its entirety.

### BACKGROUND

Numerical simulations are utilized in a wide variety of applications that involve solving differential equations that model physical phenomena, such as wave propagation, fluid flow, heat transfer and the like. Conventionally, such differential equations are solved numerically by i) discretizing the differential equation using techniques such as finite differences (FD), finite volumes (FV) or finite elements (FEM) and ii) solving the discretized differential equation using numerical solvers. Depending on the mathematical nature of the underlying equations (e.g., linear or non-linear, condition number, etc.), a variety of solvers are used to solve the differential equations. Such solvers include, among others, Gauss Newton, Jacobi, Gauss-Seidel or forward/backward substitution, for example. Numerical solvers must typically satisfy a set of stability conditions that determine the maximum possible grid size for discretization and time stepping intervals for time-dependent problems. Stability conditions in turn determine the computational cost of numerical simulators. Most numerical simulators are computationally very expensive and cannot be scaled to problem sizes of interest for many applications.

More recently, data-driven simulations using deep neural networks have emerged as an alternative approach to numerical simulations based on physical equations. In these AI-driven approaches, a deep (e.g., convolutional) neural network (DNN) is trained to approximate the solution of a numerical simulator. Most data-driven approaches are based on supervised learning in which the DNN learns the mapping between sets of numerical models and data that has been simulated using numerical solvers. One specific instance of a DNN for numerical simulations utilizes Fourier Neural Operator (FNO) networks. An FNO typically comprises a plurality of frequency domain layers that operate on a plurality of frequency modes of one or more input parameters. Each frequency domain layer includes a forward Fourier Transform (F) to transform an input to the frequency domain. In the frequency domain, a linear multiplication is performed to apply learnable weights to a down-sampled subset of the frequency modes of the input in the frequency domain. Then, up-sampling is performed to generate an output having dimensions of the original number of modes, and an inverse Fourier transform is applied to obtain an output in the time domain. Reduction of dimensionality by down-sampling the data in the frequency domain allows for the data to be processed using reduced resources, such as reduced memory and processing power perform numerical simulations. However, reduction of dimensionality by down-sampling the data in the frequency domain leads to decreased performance of the neural network in some applications, for example in applications with sharp edges in the data being simulated. As a result, conventional FNOs often do not provide sufficiently accurate simulations, particularly in applications in which sharp edges may be present in the data being simulated.

It is with respect to these and other general considerations that the aspects disclosed herein have been made. Also, although relatively specific problems may be discussed, it should be understood that the examples should not be limited to solving the specific problems identified in the background or elsewhere in this disclosure.

### SUMMARY

Aspects of the present disclosure are directed to improving data-driven neural networks for numerical simulations.

In an aspect, a method for performing a numerical simulation includes receiving input data expressed in at least a first domain. The method also includes decomposing the input data into at least i) low-pass filtered data that captures a low-pass filtered version of the input data in the at least the first domain and ii) high-pass filtered data that captures a high-pass filtered version of the input data in the at least the first domain. The method additionally includes transforming the low-pass filtered data to frequency domain and applying a first set of weights to the low-pass filtered data in the frequency domain to generate weighted low-pass filtered data in the frequency domain. The method further includes transforming the weighted low-pass filtered data from the frequency domain to the at least the first domain, and composing output data for the numerical simulation based on at least the weighted low-pass filtered data in the at least the first domain.

In another aspect, a system is provided. The system includes one or more computer readable storage media, and program instructions stored on the one or more computer readable storage media that, when executed by at least one processor, cause the at least one processor to perform operations. The operations include receiving training data for training a neural network to perform numerical simulations to model a physical phenomenon, the training data determined based on a solution of one or more differential equations that model the physical phenomenon. The operations also include training a neural network, based on the training data, to perform numerical simulations modeling the physical phenomenon, wherein the neural network is configured to operate with decomposed data. The operations further include receiving input data for a numerical simulation, the input data expressed in at least a first domain, and decomposing the input data into at least i) low-pass filtered data that captures a low-pass filtered version of the input data in the at least the first domain and ii) high-pass filtered data that captures a high-pass filtered version of the input data in the at least the first domain. The operations additionally include transforming the low-pass filtered data to frequency domain, and applying a first set of weights to the low-pass filtered data in the frequency domain to generate weighted low-pass filtered data in the frequency domain. The operations further include transforming the weighted low-pass filtered data from the frequency domain to the at least the first domain, and composing an output for the numerical simulation based on at least the weighted low-pass filtered data in the at least the first domain.

In still another aspect, a computer-readable storage medium is provided. The computer-readable storage medium stores instructions that when executed by at least one processor cause a computer system to perform operations. The operations include receiving input data for a numerical simulation, the input data expressed in at least a first domain, and decomposing the input data into at least i) low-pass filtered data that captures a low-pass filtered version of the input data in the at least the first domain and ii) high-pass filtered data that captures a high-pass filtered version of the input data in the at least the first domain. The operations also include transforming only the low-pass filtered data to frequency domain, and applying a first set of weights to the low-pass filtered data in the frequency domain to generate weighted low-pass filtered data in the frequency domain. The operations additionally include transforming the weighted low-pass filtered data from the frequency domain to the at least the first domain, and composing an output for the numerical simulation based on at least the low-pass filtered data in the at least the first domain.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

Non-limiting and non-exhaustive examples are described with reference to the following Figures.

FIG. 1 is a block diagram of an example system in which decomposed data neural operator network may be utilized, in accordance with aspects of the present disclosure.

FIG. 2 is a block diagram depicting an example implementation of a decomposed data neural operator network, in accordance with aspects of the present disclosure.

FIG. 3 is a block diagram depicting an example implementation of a decomposed data neural operator network layer, in accordance with aspects of the present disclosure.

FIG. 4 is a block diagram depicting an example implementation of a decomposed data neural operator network layer in more detail, in accordance with aspects of the present disclosure.

FIG. 5 is a diagram depicting operation of a decomposed data neural operator network, in accordance with aspects of the present disclosure.

FIG. 6 is a block diagram of an example method of performing a numerical simulation, in accordance with aspects of the present disclosure.

FIG. 7 is a block diagram illustrating physical components (e.g., hardware) of a computing device with which aspects of the disclosure may be practiced.

FIGS. 8A-8B illustrate a mobile computing device with which aspects of the disclosure may be practiced.

### DETAILED DESCRIPTION

In the following detailed description, references are made to the accompanying drawings that form a part hereof, and in which are shown by way of illustrations specific aspects or examples. These aspects may be combined, other aspects may be utilized, and structural changes may be made without departing from the present disclosure. Aspects disclosed herein may be practiced as methods, systems, or devices. Accordingly, embodiments may take the form of a hardware implementation, an entirely software implementation, or an implementation combining software and hardware aspects. The following detailed description is therefore not to be taken in a limiting sense, and the scope of the present disclosure is defined by the appended claims and their equivalents.

In accordance with examples of the present disclosure, a numerical simulator may include a frequency domain neural network that utilizes decomposed data to perform numerical simulations to provide numerical simulation output data based on the input data. The frequency domain neural network may be configured to receive input data for a numerical simulation. The input data may be expressed in a first domain, such as spatial and/or time domain, for example. The frequency domain network may decompose the input data into i) low-pass filtered data that captures a low-pass filtered version of the input data and ii) high-pass filtered data that captures a high-pass filtered version of the input data. For example, a wavelet transform may be applied to the input data to decompose the input data into the low-pass filtered data and the high-pass filtered data. The frequency domain neural network may transform only the low-pass filtered data to frequency domain. For example, the frequency domain neural network may apply a Fourier transform to only the low-pass filtered data to transform only the low-filtered data to the frequency domain. The frequency domain neural network may then apply a first set of weights to the low-pass filtered data in the frequency domain, to generate weighted low-pass filtered data in the frequency domain. The weighted low-pass filtered data may then be transformed (e.g., using an inverse Fourier transform) from the frequency domain to the original domain of the input data, such as the spatial and/or time domain of the input data. Output data for the numerical simulation may then be composed (e.g., using an inverse wavelet transform) based on at least the weighted low-pass filtered data in the original domain.

In aspects, dimensionality of the low-pass filtered data may be reduced relative to the original input data. Because dimensionality of input data is reduced prior to transformation of the data into frequency domain, less computational power may be required to perform the frequency transformation as compared to conventional Fourier Neural Operator (FNO) networks that do not decompose input data. Further, because dimensionality of the input data is reduced frequency domain neural network, further frequency domain sub-sampling need not performed in the frequency domain neural network in the frequency domain, in at least some aspects. Thus, higher frequency modes of the input data need not be zeroed our or discarded, in some aspects. Moreover, higher frequency components obtained in the decomposition of the input data may be incorporated into the output data by inverse decomposition performed to generate the output data. Thus, in at least some aspects, higher frequency components of the input data that may be relevant, for example, in applications in which sharp edges and/or discontinuities exist in the data being simulated, are maintained and are not discarded in the frequency domain neural network. These and other techniques described herein may improve performance of the frequency domain neural network as compared to a conventional FNO network, particularly in applications with sharp edges and/or discontinuities in the data being simulated by the frequency domain neural network.

It is noted that although aspects of frequency domain neural networks that operate with decomposed input data are described herein in the context of numerical simulations for exemplary purposes, the disclosed frequency domain neural networks are not so limited and may be utilized with applications other than numerical simulations, in some aspects. For example, such frequency domain neural networks that operate with decomposed input data may be used in image segmentation applications, such as image segmentation applications in which data with sharp edges and/or discontinuities may be preset in an image. As a more specific example, such frequency domain neural networks that operate with decomposed input data may be used in image segmentation for self-driving car applications, such as to classify parts of a landscape in an image, where the image may include, for example, a road and a sidewalk with a sharp edge between the road and the sidewalk. In other aspects, frequency domain neural networks that operate with decomposed input data as described herein may be utilized with other suitable applications.

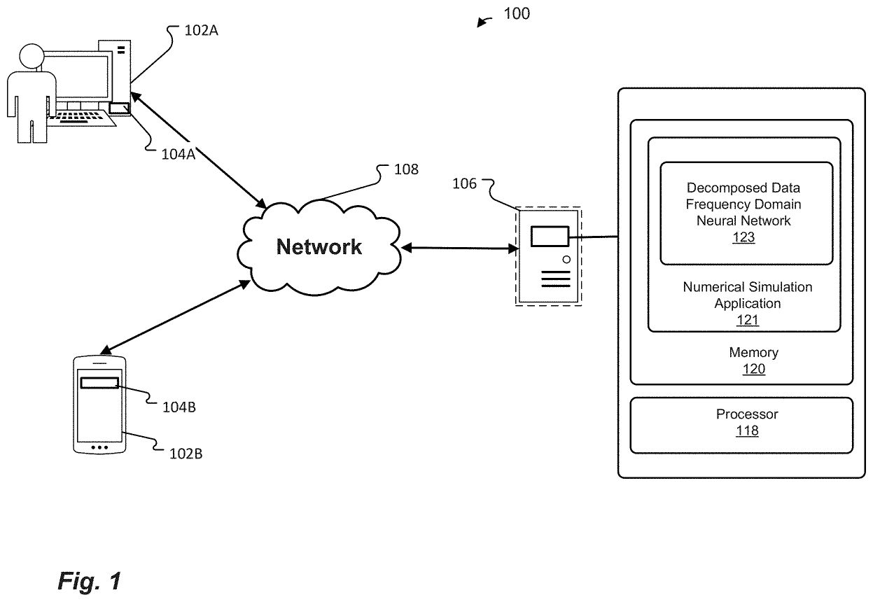

FIG. 1 is a block diagram of an example system 100 in which a frequency domain neural network that operates on decomposed input data may be utilized, in accordance with aspects the present disclosure. The system 100 may include a plurality of user devices 102 (i.e., 102A and 102B) that may be configured to run or otherwise execute client applications 104. The user devices 102 may include, but are not limited to, laptops, tablets, smartphones, and the like. The client applications 104 (i.e., 104A and 104B) may allow users of the user devices 102 to perform numerical simulations. For example, a client application 104 may comprise a user interface that may allow a user of a user device 102 to enter input parameters for the numerical simulation, to view output of the numerical simulation, etc. In some examples, the applications 104 may include web applications, where such applications 104 may run or otherwise execute instructions within web browsers. In some examples, the applications 104 may additionally or alternatively include native client applications residing on the user devices 102.

The user devices 102 may be communicatively coupled to a computing device 106 via a network 108. The computing device 106 may be a server or other computing platform generally accessible via the network 108. The computing device 106 may be a single computing device as illustrated in FIG. 1, or the computing device 106 may comprise multiple computing devices (e.g., multiple servers) that may execute the applications in a distributed manner. The network 108 may be a wide area network (WAN) such as the Internet, a local area network (LAN), or any other suit able type of network. The network 108 may be single network or may be made up of multiple different networks, in some examples.

The computing device 106 may include at least one processor 118 and a computer-readable memory 120 that stores a numerical simulation application 121 in the form of computer-readable instructions, for example, that may be executable by to at least one processor 118. Computer readable memory 121 may include volatile memory to store computer instructions and data on which the computer instructions operate at runtime (e.g., Random Access Memory or RAM) and, in an embodiment, persistent memory such as a hard disk, for example. The numerical simulation application 121 may generally be configured utilize a data-driven trained model (e.g., a frequency domain neural network as described herein) to model a physical phenomenon that may typically be modeled using differential equations, such as ordinary differential equations (ODE) or partial differential equations (PDE). For example, in an industrial CO₂ storage scenario, the numerical simulation application 121 may model the flow or propagation of carbon dioxide (CO₂) in the subsurface a CO₂ injection site used to trap CO₂ in the sub-surface in supercritical state. In this case, the model may represent two-phase flow simulation of CO₂ in the supercritical state.

The numerical simulation application 121 may include a frequency domain neural network 123 (sometimes referred to herein as “decomposed data frequency domain neural network”) configured to operate with decomposed data. In aspects, the frequency domain neural network 123 may be configured receive input data for a numerical simulation, and to decompose (e.g., using a wavelet transform) the input data into i) reduced dimensionality low-pass filtered data that captures relatively lower frequency components of the input data and ii) reduced dimensionality high-pass filtered data that captures relatively higher frequency components of the input data. The low-pass filtered data may be transformed (e.g., using a Fourier transform) into frequency domain, generating a plurality of frequency modes of the low-pass input data in the frequency domain. The frequency domain neural network 123 may apply learnable weights to the frequency modes of the low-pass filtered data to generate weighted low-pass filtered data in the frequency domain. An inverse frequency transform (e.g., inverse Fourier transform) may then be applied to the weighted low-pass filtered data in the frequency domain to transform the weighted low-pass filtered data to the original domain of the input data. Inverse decomposition (e.g., inverse wavelet transform) may be applied to the weighted low-pass filtered data in the original domain to generate output data of for the numerical simulation. In some aspects, inverse decomposition of the weighted low-pass filtered data in the original domain may include combining the weighted low-pass filtered in the original domain with the high-pass fileted data that was obtained by decomposition of the input data in the original domain. In some aspects, weights may also be applied to the high-pass fileted input data to generate weighted high-pass filtered data, and the inverse decomposition may be performed based on a combination of the weighted low-pass filtered data and the weighted high-pass filtered output data.

The numerical simulator application 121 may be configured to train the frequency domain neural network 123 to infer, from input data, results of differential equations that model a physical phenomenon. The input data may be multi-dimensional data, such as input data corresponding to a mesh grid of values describing input parameters in spatial and/or temporal domains. As an example, in a CO₂ storage application, the input data may include, but not limited to, one or more of permeability and/or porosity of the sub-terrain (e.g., rock or earth) into which CO₂ is to be injected, control parameters of an injection well used for CO₂ injection, such as the location of the well, the depth of the well, the well perforation, the well pressure, etc. In an aspect, the decomposed input frequency neural operator network 123 may be trained using supervised learning in which the decomposed input frequency neural operator network 123 may learn mapping between a set of numerical model and data that has been simulated numerical solvers modeling differential equations. Thus, for example, in the CO₂ storage application, the frequency domain neural network 123 may infer saturation and/or pressure distribution of CO₂ as a function of time, for example. In an aspect, the decomposed input frequency neural operator network 123 may be mesh-invariant in that once the decomposed input frequency neural operator network 123 is trained on input data corresponding to a particular mesh grid, the decomposed input frequency neural operator network 123 may be used to infer result from input data corresponding to a different mesh grid. The numerical simulator application 121 may also be configured to receive input parameters from a user device 102 via the network 108, and to run a numerical simulation using the trained frequency domain neural network 123 to generate an output simulating results of the differential equations modeling the physical phenomenon. The simulated results may be provided via the network 108 to the user device 102, and may be displayed, in some manner, to a user of the user device 102, for example in a user interface of the client application 104 running or otherwise executing on the user device 102.

While the numerical simulator application 121 and the decomposed input frequency neural operator network 123 are illustrated as being executed by a computing device (e.g., server) 106, the numerical simulator application 121 and/or the frequency domain neural network 123 may be at least partially executed at a client application 104. For example, the computing device 106 may be configured to train the wavelet frequency domain neural network 123, and the trained decomposed input frequency neural operator network 123 may be executed locally at a client application 104. Moreover, the numerical simulator application 121 may at least partially reside at the client application 104.

It is noted that although, for exemplary purposes, the frequency domain neural network 123 is described herein in the context of numerical simulations, the frequency domain neural network 123 is not so limited, and a frequency domain neural network same as or similar to the frequency domain neural network 123 may be utilized with applications other than numerical simulations, in some aspects. For example, a frequency domain neural network same as or similar to the frequency domain neural network 123 may be used in image segmentation applications, such as, for example, self-car driving image segmentation applications, where a frequency domain neural network same as or similar to the frequency domain neural network 123 may be trained and utilized to classify parts of a landscape in an image, where the image may include, for example, a road and a sidewalk with a sharp edge between the road and the sidewalk. In other aspects, frequency domain neural networks same as or similar to the frequency domain neural network 123 may be utilized in other suitable applications.

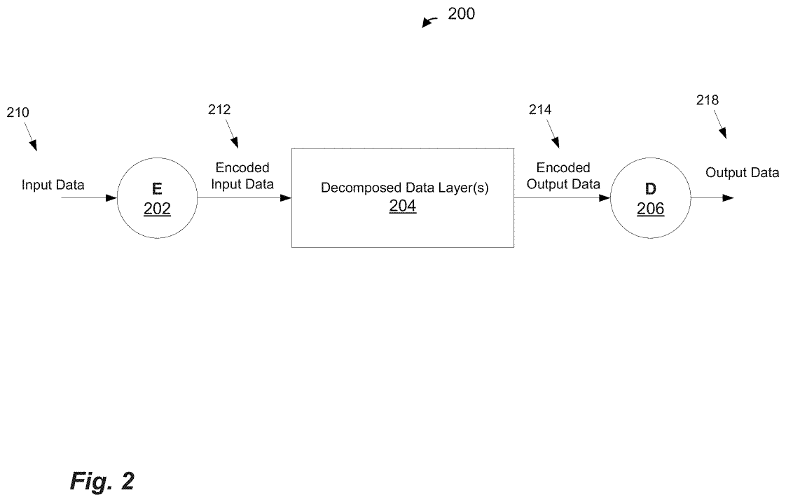

FIG. 2 is a block diagram depicting an example implementation of frequency domain neural network 200, in accordance with aspects of the present disclosure. In aspects, the frequency domain neural network 200 may correspond to the decomposed input frequency neural operator network 123 of system 100 of FIG. 1. In other aspects, the frequency domain neural network 200 may be utilized with a system different from the system 100 of FIG. 1.

The frequency domain neural network 200 may include an encoder 202, one or more neural network layers 204 configured to operate with decomposed input data and a decoder 206. The encoder 202 may be configured to encode input data 210, such as input parameter(s), to generate encoded input data 212. In an aspect, the encoder 202 may perform a convolution (e.g., 1×1 convolution) to increase channel dimensionality of the input data 212. The input data 210 may include, for example, one or more input operator parameters for a numerical simulation. As an example, in a CO₂ storage application, the input data 212 may include, but not limited to, one or more of permeability and/or porosity of the sub-terrain (e.g., rock or earth) into which CO₂ is to be injected, control parameters of an injection well used for CO₂ injection, such as the location of the well, the depth of the well, the well perforation, the well pressure, etc.

The encoded input data 212 may be successively processed by the one or more neural network layers 204 to generate encoded output data 214. Processing of the encoded input data 212 by each of the one or more neural network layers 204 may include decomposing the input data provided to the neural network layer 204 into i) reduced dimensionality low-pass filtered data that captures relatively lower frequency components of the input data and ii) reduced dimensionality high-pass filtered data that captures relatively higher frequency components of the input data. For example, a wavelet transform wavelet transform, such as a discrete wavelet transform (DWT), may be utilized to transform the input data i) reduced dimensionality low-pass filtered data that captures relatively lower frequency components of the input data and ii) reduced dimensionality high-pass filtered data that includes wavelet coefficients capturing relatively higher frequency components of the input data. The low-pass filtered input data may be transformed (e.g., using a Fourier transform) into frequency domain, and weights may be applied in the neural network layer 204 to frequency modes of the low-pass filtered data in the frequency domain to generate weighted low-pass filtered data in the frequency domain. The weighted low-pass filtered data may be transformed (e.g., using an inverse Fourier transform) to the original domain of the input data 210. An output of the neural network layer 204 may be composed based on at least the weighted low-pass filtered data in the original domain. Encoded output data 214 may be thus generated in the last neural network layer 204 among the one or more decomposed data neural network layers 204. The encoded output data 214 may be provided to the decoder 206 which may, in turn, decode the encoded output data 214 to generate output data 218, such as output data of the numerical simulation. In an aspect, the decoder 206 may perform a convolution (e.g., 1×1 convolution) to transform the time and/or spatial domain encoded output data 214 data back to the original dimensions of the input channel.

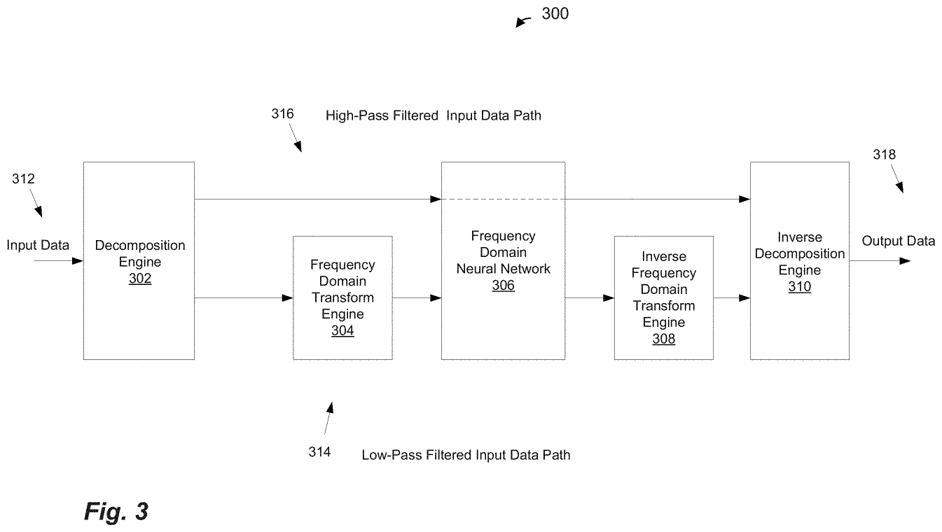

FIG. 3 is a block diagram depicting an example implementation of a neural network layer 300 configured to operate with decomposed input data, in accordance with aspects of the present disclosure. In an aspect, the neural network layer 300 may correspond to a neural network layer 204, among the one or more neural networks layer 204, of the frequency domain neural network 200 of FIG. 2. In other aspects, the neural network layer 300 may be utilized with neural networks different from the frequency domain neural network 200 of FIG. 2.

The neural network layer 300 may include a decomposition engine 302, a frequency domain transform engine 304, a frequency domain neural network 306, an inverse frequency domain transform engine 308, and an inverse decomposition engine 310. The decomposition engine 302 may decompose input data 312 (e.g., corresponding to the encoded input data 212 if the neural the neural network layer 300 is the first neural network layer in the network, or corresponding to input data provided by a previous neural network layer if the neural the neural network layer 300 in the network) into i) reduced dimensionality low-pass filtered data that captures relatively lower frequency components of the input data 312 and ii) reduced dimensionality high-pass filtered data that captures relatively higher frequency components of the input data 312. In aspects, the decomposition engine 302 may apply a wavelet transform, such as a discrete wavelet transform (DWT), to the input data to decompose the input data 312 into i) reduced dimensionality low-pass filtered data that captures relatively lower frequency components of the input data 312 and ii) reduced dimensionality high-pass filtered data that includes wavelet coefficients capturing coefficients capturing relatively higher frequency components of the input data 312.

In aspects, the dimensionality of the low-pass filtered data may be reduced relative to full dimensionality of the input data 312. The degree of reduction in dimensionality may depend on dimensionality of the input data and a number of transform levels, such as DWT levels, applied to the input data 312. As an example, in an aspect in which dimensionality of the input data corresponds to a two-dimensional physical space, a single level wavelet transform may reduce dimensionality of the input data by a factor of 4 relative to full dimensionality of the input data 312. Thus, in an example in which the input data 312 corresponds to a two-dimensional physical space and the decomposition engine 302 applies a single-level DWT to decompose the input data, dimensionality of the low-pass filtered data is reduced by a factor of 4 relative to the full-dimensional input data 312. As another example, in an aspect in which dimensionality of the input data 312 corresponds to a three-dimensional physical space, a single level wavelet transform may reduce dimensionality of the input data by a factor of 8 relative to full dimensionality of the input data 312. Thus, in an example in which the input data 312 corresponds to a three-dimensional physical space and the decomposition engine 302 applies a single-level DWT to decompose the input data, dimensionality of the low-pass input data is reduced by a factor of 8 relative to the full-dimensional input data 312. In some aspects, a multi-level (e.g., 2-level, 3-level, etc.) transform, such as a multi-level (e.g., 2-level, 3-level, etc.) transform, may be applied to the input data to further reduce dimensionality relative to the dimensionality of the input data 312.

The reduced-dimensionality low-pass filtered data obtained from decomposition performed by the decomposition engine 302 may be provided to a low-pass filtered data path 314, and the high-pass filtered into data obtained from decomposition performed by the decomposition engine 302 may be provided to the high-pass filtered data path 316. Referring first to the low-pass filtered data path 314, the frequency domain transform engine 304 may transform the reduced dimensionality low-pass filtered data into frequency domain. The frequency domain transform engine 304 may, for example, implement a Fourier transform, such as a discrete Fourier transform (DFT), to transform the reduced dimensionality low-pass filtered data into the frequency domain. Transforming the reduced dimensionality low-pass filtered data into the frequency domain may involve generating a plurality of frequency modes of the reduced dimensionality low-pass filtered data in the frequency domain. In aspects, because the frequency domain transform engine 304 operates on reduced dimensionality low-pass filtered data, no further sub-sampling of the frequency modes is performed in the frequency domain. In some aspects, however, additional sub-sampling of frequency modes may be performed in the frequency domain, for example if non-even number of frequency modes is desired in the frequency domain. As just in example, in an aspect in which a number of frequency modes generated based on reduced dimensionality low-pass filtered data that resulted from a single-level DWT is 24 frequency modes, but the desired number of modes is a number less than 24 frequency modes (e.g., 23, 22, 21, etc.) frequency modes, then further sub-subsampling of modes may be performed in the frequency domain. Sub-sampling of modes in the frequency domain may involve keeping frequency data corresponding to the desired number of frequency modes and discarding or zeroing-out the remaining frequency modes. For example, sub-sampling of the frequency modes may involve keeping only a subset of lower-indexed frequency modes (e.g., the first k frequency modes) and discarding higher-indexed frequency modes. In other aspects, other suitable sub-sampling techniques may be utilized.

With continued reference to FIG. 3, the frequency domain neural network 306 may apply learnable weights to the frequency modes (or the sub-sampled frequency modes) of the reduced dimensionality low-pass filtered data, generated by the frequency domain transform engine 304, to generate weighted low-pass filtered data in the frequency domain. The weighted low-pass filtered data in the frequency domain may be provided to the inverse frequency domain engine 308. The inverse frequency domain engine 308 may transform the weighted low-pass data in the frequency domain into the original domain of the input data.

The weighted low-pass data in the original domain of the input data may be provided to an inverse decomposition engine 310. The inverse decomposition engine 310 may compose output data 318 based at least on the weighted low-pass data in the original domain. For example, the inverse decomposition engine 310 may apply an inverse wavelet transform, such as an inverse discrete wavelet transform (IDWT), to least on the weighted low-pass data in the original domain. In some aspects, the high-pass filtered data that may be provided to the inverse decomposition engine 310 via the high-pass filtered data path 316, and the inverse decomposition engine 310 may generate output data 318 based on both i) the weighted low-pass filtered data in the original domain and ii) the high-pass filtered data in the original domain. In some aspects, the frequency domain neural network 306 may also apply learnable weights to the high-pass filtered data to generate weighted high-pass filtered data, and the inverse decomposition engine 310 may combine the weighted low-pass filtered data and the weighted high-pass filtered data to generate the output data 318. In yet another example, the high-pass filtered data may be zeroed out or discarded. In this example, the inverse decomposition engine 310 may generate output data based on only the weighted low-pass filtered data.

In aspects, the output data 318 may be provided to a next neural network layer if the neural network layer 300 is not the layer in the frequency domain neural network. If the neural network layer 300 is not the layer in the frequency domain neural network, the output data 318 may correspond to the output of the numerical simulation. In some aspects, the output data 318 may then be decoded to provide the output of the numerical simulation. In some aspects, the output data 318 may be provided to an activation function of the frequency domain neural network, and the activation function may generate, based on the output data 318, an output to be decoded to provide the output of the numerical simulation.

Referring still to FIG. 3, it is noted that in some aspects, the frequency domain neural network 306 may comprise a single frequency domain layer that may include a plurality of stages, each stage i) performing a linear operation to apply a set of learnable weights (e.g., complex weights) to frequency modes of input data (or the sub-sampled frequency modes) and ii) applying a non-linear transformation to the frequency modes of the input data (or the sub-sampled frequency modes) as described in U.S. patent application Ser. No. ______ (Attorney Docket No. 410706-US-NP), filed on the same day as the present application, entitled “Fourier Neural Operator Networks with Sub-Sampled Non-Linear Transformations,” which is incorporated by reference herein in its entirety.

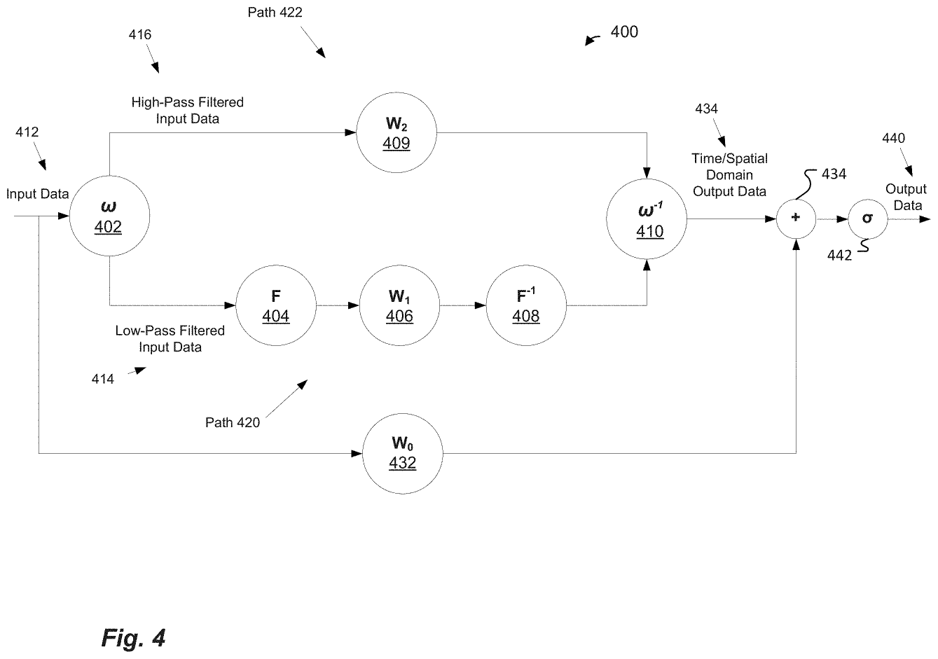

FIG. 4 is a block diagram depicting an example implementation of a neural network layer 400 in more detail, in accordance with aspects of the present disclosure. In aspects, the neural network layer 400 corresponds to a neural network layer 204 of FIG. 2 and/or the neural network layer 300 of FIG. 3. The neural network layer 400 includes a decomposition engine 402 that may correspond to the decomposition engine 302 of FIG. 3. The decomposition engine 402 may apply a wavelet transform (e.g., a DWT) to input data 412 (e.g., corresponding to input data 312) to decompose the input data 412 into i) reduced dimensionality low-pass filtered data 414 that captures relatively lower frequency components of the input data 412 and ii) reduced dimensionality high-pass filtered data 416 that includes wavelet coefficients capturing coefficients capturing relatively higher frequency components of the input data 412. In aspects, with the neural network layer 400 being layer t of the frequency domain neural network (where t is an integer), the decomposition engine 402 may compute a single-layer or a multi-layer DWT of input vₜ(x) that may correspond to the input data 412 to the neural network layer t. In an aspect, the decomposition engine 402 may compute the low-pass filtered data 414 according to

$$\text{?} \qquad Equation 1$$

$$\text{?} \text{indicates text missing or illegible when filed}$$

and calculate the high-pass filtered input data 416 according to

$$\text{?} \qquad Equation 2$$

$$\text{?} \text{indicates text missing or illegible when filed}$$

where the functions g(x) and h(x) may be, respectively, a set of low-pass filters and a set of high-pass filters, having suitable filter coefficients that may depend a type of wavelet (e.g., Haar, Deubechies, etc.) being utilized. In aspects, each of the low-pass filtered data 414 and the low-pass filtered data 414 may have reduced dimensionality relative to the input data 412. In an aspect, dimensionality of each of the low-pass filtered data 414 and the low-pass filtered data 414 may be reduced by a factor of two in each dimension and at each level of the DWT. Thus, for example, with input data 412 having two spatial dimensions (2D data) and a single-level DWT, each of the low-pass filtered data 414 and the low-pass filtered data 414 may have reduced dimensionality by a factor 4 relative to the input data 412. As another example, with input data 412 having three spatial dimensions (3D data) and a single-level DWT, each of the low-pass filtered data 414 and the low-pass filtered data 414 may have reduced dimensionality by a factor 6 relative to the input data 412.

The low-pass filtered data 414 may be processed in a path 420 of the neural network layer 400. The path 420 may include a frequency domain transform engine 404 (that may correspond to the frequency domain transform engine 304 of FIG. 3). The frequency domain transform engine 404 may transform the low-pass filtered data 414 into frequency domain, generating a plurality of modes of the low-pass filtered data 414 in the frequency domain. For example, the frequency domain transform engine 404 may apply a DFT to the low-pass filtered data 414 to transform the low-pass filtered data 414 into frequency domain, generating a plurality of modes of the low-pass filtered data 414 in the frequency domain. In some aspects, further sub-sampling of the frequency modes may be performed in the frequency domain, for example to further reduce dimensionality of the low-pass filtered data 414 in the frequency domain. In other aspects, no further sub-sampling of the frequency modes is performed in the frequency domain.

With continued reference to the path 420 in FIG. 4, weights W₁ 406 may be applied to the frequency modes of the low-pass filtered data 414 in the frequency domain to generate weighted low-pass filtered data in the frequency domain. The path 420 may additionally include an inverse frequency domain transform engine 408 configured to transform the weighted low-pass filtered data in the frequency domain back to the original domain of the input data 412 (e.g., time and/or space domain). In an aspect, the inverse frequency domain transform engine 408 configured perform the transformation according to

$$\text{?} \qquad Equation 3$$

$$\text{?} \text{indicates text missing or illegible when filed}$$

where F stands for DFT, F⁻¹ stands for IDFT, i and j are indices corresponding to dimensions of the data, and k is the frequency mode index.

An inverse decomposition engine 410 may compose output data 434 in the original domain based at least on the weighted low-pass filtered data in the original domain. In an aspect, the inverse decomposition engine 410 may apply an inverse wavelet transform to at least the weighted low-pass filtered data in the original domain. In some aspects, the inverse decomposition engine 410 may compose output data 434 further based on high-pass filtered data 416 in the original domain that may be provided to the inverse decomposition engine 410 via a data path 422. In some aspects, weights W₂ 409 may be applied to the high-pass filtered data 416 in the original domain, and the inverse decomposition engine 410 may compose the output data 434 further based on the weighted high-pass filtered data 416 in the original domain. In an aspect, the inverse decomposition engine 410 may apply an inverse wavelet transform to a combination of i) the weighted low-pass filtered data in the original domain and ii) the weighted or unweighted high-pass filtered data in the original domain.

In some aspects in which weights W₂ 409 are applied to the high-pass filtered data 416, applying the weights W₂ 409 to the high-pass filtered data 416 may include applying the weights W₂ 409 to a subset of high frequency coefficients in the high-pass filtered data 416, where the subset includes one or both of i) a subset of largest magnitude high frequency coefficients in the high-pass filtered data 416 and ii) a subset of smallest magnitude high frequency coefficients in the high-pass filtered data 416. For example, the high-pass filtered data 416 may be sorted according to magnitude of frequency coefficients in the high-pass filtered data 416, weights W₂ 409 may be applied to a subset of highest magnitude and/or lowest magnitude frequency coefficients, and the high-pass filtered data 416 with the weighted coefficients may be sorted back to the original order. In another aspect, weights W₂ 409 may be applied to all frequency coefficients in the high-pass filtered data 416.

Referring still to FIG. 4, in some aspects, a linear transform W₀ 432 (e.g., 1×1 convolution) may be applied to the time and/or frequency domain input data 412, and the result may be added to the output data 434 by a summer 438 to produce output data 440. In some aspects, a time and/or spatial domain non-linear activation function σ 442 may apply a point-wise non-linear transformation to the resulting time and/or spatial domain output to produce the output data 440. The time and/or frequency domain non-linear activation function σ 442 may comprise a rectified linear unit (ReLU), for example. In other aspects, other suitable non-linear activation functions may be utilized.

In aspects, training of frequency domain layers, such as frequency domain layer 400, of a frequency domain neural network may be performed based on training data, such as training data generated using numerical solvers to salve differential equations. Training of the frequency domain layers, such as frequency domain layer 400 may include learning of weights, such as weights W₁ 406 to be applied to low-pass filtered data. In some aspects, training of the frequency domain layers, such as frequency domain layer 400, may additionally include learning of weights W₂ 409 to be applied to high-pass filtered data and or linear transform weights W₀ 432. In aspects, end-to-end training of the frequency domain neural network may be performed. In aspects, training may be performed using common deep learning libraries such as PyTorch, TensorFlow, Caffe, MXNet, or with conventional linear algebra packages such as Numpy. Training of the network may involve supervised training in which the data misfit (e.g., L2-norm) between the network output and training data is minimized using convex optimization algorithms (e.g., stochastic gradient descent, ADAM, etc.). In other aspects, other suitable training methods may be employed. In aspects, a trained model (e.g., weights W₁ 406, W₂ 409 and/or W₀ 432) may be saved in a memory, such as the memory 120 or another memory included in or otherwise accessible (e.g., via the network 108) by the server 106, and may subsequently be retrieved from the memory (e.g., by the numerical simulation application 121) and utilized for performing numerical simulations.

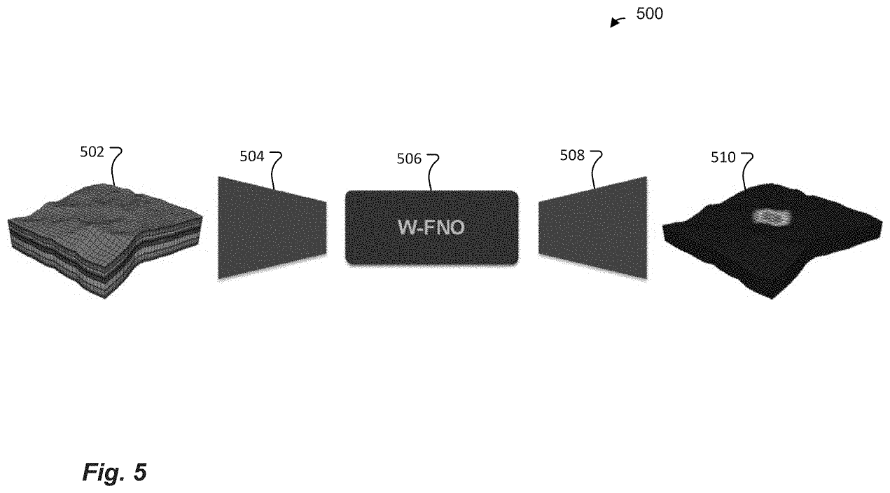

FIG. 5 is a diagram depicting operation of a frequency domain neural network 500 configured to operate with decomposed data, in accordance with aspects of the present disclosure. The frequency domain neural network 500 may model CO₂ flow, for example. The frequency domain neural network 500 may include one or more layers 503 configured to successively process received input data 502. Input data 502 may be multi-dimensional grid data in spatial and/or time domain, for example. The input data 502 may comprise input parameters such as parameters of a reservoir into which CO₂ is injected, rock properties (e.g., rock permeability), injections parameters (e.g., injection well physical dimensions), etc. In each of the one or more neural network layers 503, an input transform block 504 may encode the input data 502, decompose the encoded input data into reduced dimensionality low-pass filtered data and reduced dimensionality high-pass filtered data, and transform only the reduced dimensionality low-pass filtered data into frequency domain. A neural network block 506 may apply learnable weights to the reduced dimensionality low-pass filtered data in the frequency domain to generate weighted low-pass filtered data in the frequency domain. An output transformation block 508 may transform the weighted low-pass filtered data from the frequency domain to the spatial and/or time domain, and compose output data based on at least the resulting data to the time and/or spatial domain to generate output data 510. The output data 510 of the last neural network layer of the one or more neural network layers 503 may represent simulated CO₂ saturation and pressure in the subsurface as a function of time.

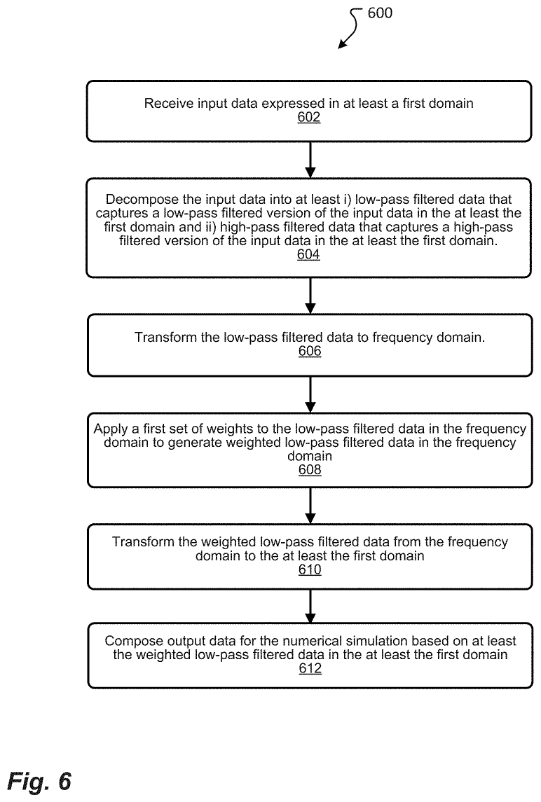

FIG. 6 is a block diagram of an example method 600 for performing a numerical simulation, in accordance with aspects of the present disclosure. A general order for the steps of the method 600 is shown in FIG. 6. The method 600 can be executed as a set of computer-executable instructions executed by a computer system and encoded or stored on a computer readable medium. Further, the method 600 can be performed by gates or circuits associated with a processor, Application Specific Integrated Circuit (ASIC), a field programmable gate array (FPGA), a system on chip (SOC), or other hardware device. Hereinafter, the method 600 shall be explained with reference to the systems, components, modules, software, data structures, user interfaces, etc. described in conjunction with FIGS. 1-5.

At block 602, input data is received. The input data may be expressed in at least a first domain. The at least the first domain may comprise spatial and/or time domain, for example. The input data may be multi-dimensional grid data, for example. In an aspect, the input data may comprise one or more parameters of a CO₂ injection site for which CO₂ flow modeling is to be performed. In other aspects, the input data may comprise other input parameters for performing other suitable simulations, such as wave propagation, fluid flow, heat transfer, etc.

At block 604, the input data received at block 602 is decomposed the input data into at least i) low-pass filtered data that captures a low-pass filtered version of the input data in the at least the first domain and ii) high-pass filtered data that captures a high-pass filtered version of the input data in the at least the first domain. The low-pass filtered data and the high-pass filtered data may each comprise dimensionality that is reduced relative to dimensionality of the input data receive at block 602. In an example, a discrete wavelet transform is applied to the input data to decompose the input data into the reduced dimensionality low-pass filtered data and the reduced dimensionality high-frequency filtered data. In other aspects, other decomposition or filtering techniques may be utilized.

At block 606, the low-pass filtered data to frequency domain is transformed into frequency domain. In an aspect, the method includes performing the frequency domain transformation only on the low-pass filtered data, without performing frequency domain transformation on the high-pass filtered data. In an aspect, transforming the input data at block 606 includes generating a plurality of frequency modes of the input data in the frequency domain. For example, a discrete Fourier transform (DFT) is applied to the input data to generate a plurality of frequency modes of the input data in the frequency domain. In other aspects, other suitable other suitable transformations may be applied to transform the input data.

At block 608, a first set of weights is applied to the low-pass filtered data in the frequency domain to generate weighted low-pass filtered data in the frequency domain, and, at block 610, the weighted low-pass filtered data from the frequency domain to the at least the first domain. For example, an inverse DFT is applied to the weighted low-pass filtered data to transform the weighted low-pass filtered data from the frequency domain to the at least the first domain (e.g., spatial and/or time domain).

At block 612, output data for the numerical simulation is composed based on at least the weighted low-pass filtered data in the at least the first domain. For example, an inverse discrete wavelet transformed may be applied to the at least the weighted low-pass filtered data in the at least the first domain. In some aspects, the inverse discrete wavelet transformed may be applied to the weighted low-pass filtered data in the at least the first domain and weighted or unweighted high-pass filtered data obtained by decomposition of input data at block 604 in the at least the first domain. The output data for the numerical simulation may comprise simulated flow of CO₂ in an injection site, for example.

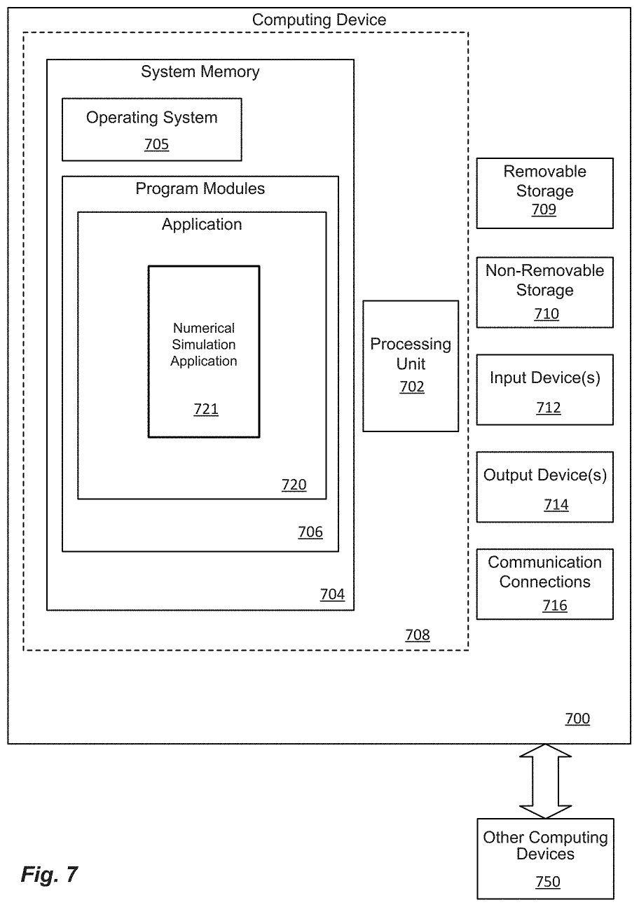

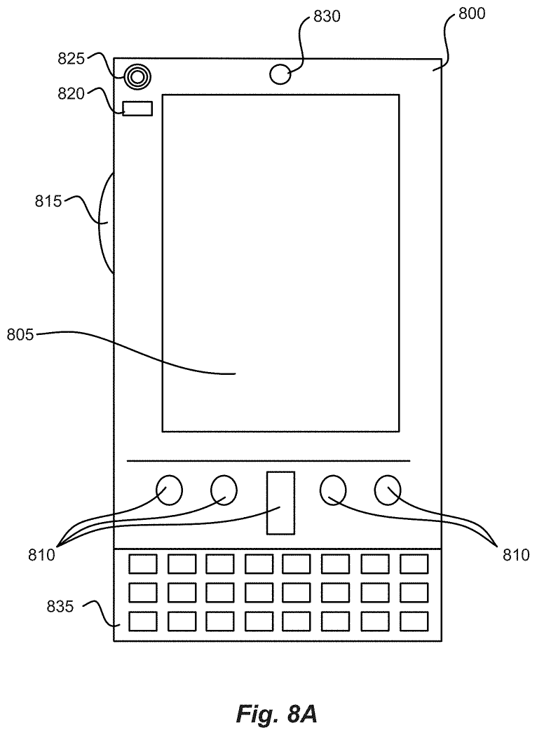

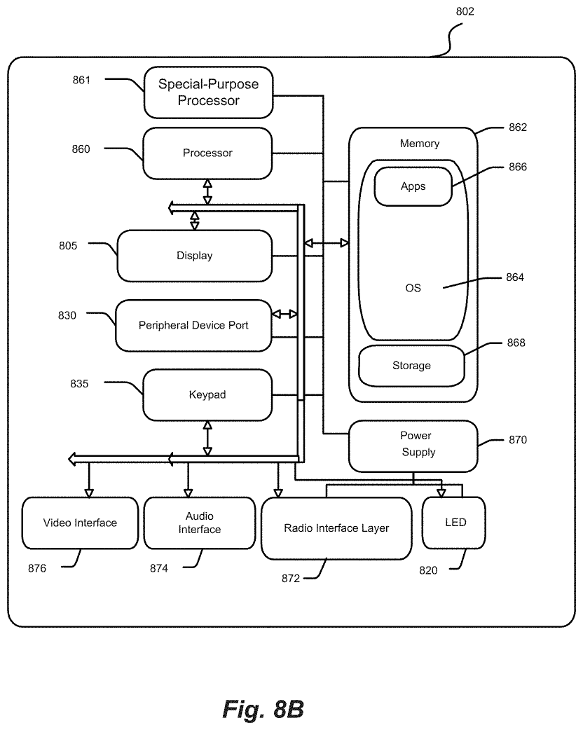

FIGS. 7-8 and the associated descriptions provide a discussion of a variety of operating environments in which aspects of the disclosure may be practiced. However, the devices and systems illustrated and discussed with respect to FIGS. 7-18 are for purposes of example and illustration and are not limiting of a vast number of computing device configurations that may be utilized for practicing aspects of the disclosure, described herein.

FIG. 7 is a block diagram illustrating physical components (e.g., hardware) of a computing device 700 with which aspects of the disclosure may be practiced. The computing device components described below may be suitable for the computing devices described above. In a basic configuration, the computing device 700 may include at least one processing unit 702 and a system memory 704. Depending on the configuration and type of computing device, the system memory 704 may comprise, but is not limited to, volatile storage (e.g., random access memory), non-volatile storage (e.g., read-only memory), flash memory, or any combination of such memories.

The system memory 704 may include an operating system 705 and one or more program modules 706 suitable for running software application 720, such as one or more components supported by the systems described herein. As examples, system memory 704 may store a numerical simulator application 721 (e.g., corresponding to the numerical simulator application 121 of FIG. 1). The operating system 705, for example, may be suitable for controlling the operation of the computing device 700.

Furthermore, aspects of the disclosure may be practiced in conjunction with a graphics library, other operating systems, or any other application program and is not limited to any particular application or system. This basic configuration is illustrated in FIG. 7 by those components within a dashed line 708. The computing device 700 may have additional features or functionality. For example, the computing device 700 may also include additional data storage devices (removable and/or non-removable) such as, for example, magnetic disks, optical disks, or tape. Such additional storage is illustrated in FIG. 7 by a removable storage device 709 and a non-removable storage device 710.

As stated above, a number of program modules and data files may be stored in the system memory 704. While executing on the at least one processing unit 702, the program modules 706 (e.g., application 721) may perform processes including, but not limited to, the aspects, as described herein. Other program modules that may be used in accordance with aspects of the present disclosure may include electronic mail and contacts applications, word processing applications, spreadsheet applications, database applications, slide presentation applications, drawing or computer-aided application programs, etc.

Furthermore, aspects of the disclosure may be practiced in an electrical circuit comprising discrete electronic elements, packaged or integrated electronic chips containing logic gates, a circuit utilizing a microprocessor, or on a single chip containing electronic elements or microprocessors. For example, aspects of the disclosure may be practiced via a system-on-a-chip (SOC) where each or many of the components illustrated in FIG. 7 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to the capability of client to switch protocols may be operated via application-specific logic integrated with other components of the computing device 700 on the single integrated circuit (chip). Aspects of the disclosure may also be practiced using other technologies capable of performing logical operations such as, for example, AND, OR, and NOT, including but not limited to mechanical, optical, fluidic, and quantum technologies. In addition, aspects of the disclosure may be practiced within a general purpose computer or in any other circuits or systems.

The computing device 700 may also have one or more input device(s) 712 such as a keyboard, a mouse, a pen, a sound or voice input device, a touch or swipe input device, etc. The output device(s) 714 such as a display, speakers, a printer, etc. may also be included. The aforementioned devices are examples and others may be used. The computing device 700 may include one or more communication connections 716 allowing communications with other computing devices 750. Examples of suitable communication connections 716 include, but are not limited to, radio frequency (RF) transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program modules. The system memory 704, the removable storage device 709, and the non-removable storage device 710 are all computer storage media examples (e.g., memory storage). Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information, and which can be accessed by the computing device 700. Any such computer storage media may be part of the computing device 700. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

FIGS. 8A-8B illustrate a mobile computing device 800, for example, a mobile telephone, a smart phone, wearable computer (such as a smart watch), a tablet computer, a laptop computer, and the like, with which aspects of the disclosure may be practiced. In some aspects, the client (e.g., client device 102A, 102B) may be a mobile computing device. With reference to FIG. 8A, one aspect of a mobile computing device 800 for implementing the aspects is illustrated. In a basic configuration, the mobile computing device 800 is a handheld computer having both input elements and output elements. The mobile computing device 800 typically includes a display 805 and one or more input buttons that allow the user to enter information into the mobile computing device 800. The display 805 of the mobile computing device 800 may also function as an input device (e.g., a touch screen display). If included, an optional side input element 815 allows further user input. The side input element 815 may be a rotary switch, a button, or any other type of manual input element. In alternative aspects, mobile computing device 800 may incorporate more or less input elements. For example, the display 805 may not be a touch screen in some aspects. In yet another alternative aspect, the mobile computing device 800 is a portable phone system, such as a cellular phone. The mobile computing device 800 may also include an optional keypad 835. Optional keypad 835 may be a physical keypad or a “soft” keypad generated on the touch screen display. In various aspects, the output elements include the display 805 for showing a graphical user interface (GUI), a visual indicator 820 (e.g., a light emitting diode), and/or an audio transducer 825 (e.g., a speaker). In some aspects, the mobile computing device 800 incorporates a vibration transducer for providing the user with tactile feedback. In yet another aspect, the mobile computing device 800 incorporates input and/or output ports, such as an audio input (e.g., a microphone jack), an audio output (e.g., a headphone jack), and a video output (e.g., a HDMI port) for sending signals to or receiving signals from an external source.

FIG. 8B is a block diagram illustrating the architecture of one aspect of computing device, a server, or a mobile computing device. That is, the computing device 800 can incorporate a system (e.g., an architecture) 802 to implement some aspects. The system 802 can implemented as a “smart phone” capable of running one or more applications (e.g., browser, e-mail, calendaring, contact managers, messaging clients, games, and media clients/players). In some aspects, the system 802 is integrated as a computing device, such as an integrated personal digital assistant (PDA) and wireless phone.

One or more application programs 866 may be loaded into the memory 862 and run on or in association with the operating system 864. Examples of the application programs include phone dialer programs, e-mail programs, personal information management (PIM) programs, word processing programs, spreadsheet programs, Internet browser programs, messaging programs, and so forth. The system 802 also includes a non-volatile storage area 868 within the memory 862. The non-volatile storage area 868 may be used to store persistent information that should not be lost if the system 802 is powered down. The application programs 866 may use and store information in the non-volatile storage area 868, such as e-mail or other messages used by an e-mail application, and the like. A synchronization application (not shown) also resides on the system 802 and is programmed to interact with a corresponding synchronization application resident on a host computer to keep the information stored in the non-volatile storage area 868 synchronized with corresponding information stored at the host computer. As should be appreciated, other applications may be loaded into the memory 862 and run on the mobile computing device 800 described herein (e.g., search engine, extractor module, relevancy ranking module, answer scoring module, etc.).

The system 802 has a power supply 870, which may be implemented as one or more batteries. The power supply 870 might further include an external power source, such as an AC adapter or a powered docking cradle that supplements or recharges the batteries.

The system 802 may also include a radio interface layer 872 that performs the function of transmitting and receiving radio frequency communications. The radio interface layer 872 facilitates wireless connectivity between the system 802 and the “outside world,” via a communications carrier or service provider. Transmissions to and from the radio interface layer 872 are conducted under control of the operating system 864. In other words, communications received by the radio interface layer 872 may be disseminated to the application programs 866 via the operating system 864, and vice versa.

The visual indicator 820 may be used to provide visual notifications, and/or an audio interface 874 may be used for producing audible notifications via the audio transducer 825. In the illustrated configuration, the visual indicator 820 is a light emitting diode (LED) and the audio transducer 825 is a speaker. These devices may be directly coupled to the power supply 870 so that when activated, they remain on for a duration dictated by the notification mechanism even though the processor 860 and other components might shut down for conserving battery power. The LED may be programmed to remain on indefinitely until the user takes action to indicate the powered-on status of the device. The audio interface 874 is used to provide audible signals to and receive audible signals from the user. For example, in addition to being coupled to the audio transducer 825, the audio interface 874 may also be coupled to a microphone to receive audible input, such as to facilitate a telephone conversation. In accordance with aspects of the present disclosure, the microphone may also serve as an audio sensor to facilitate control of notifications, as will be described below. The system 802 may further include a video interface 876 that enables an operation of an on-board camera 830 to record still images, video stream, and the like.

A mobile computing device 800 implementing the system 802 may have additional features or functionality. For example, the mobile computing device 800 may also include additional data storage devices (removable and/or non-removable) such as, magnetic disks, optical disks, or tape. Such additional storage is illustrated in FIG. 8B by the non-volatile storage area 868.

Data/information generated or captured by the mobile computing device 800 and stored via the system 802 may be stored locally on the mobile computing device 800, as described above, or the data may be stored on any number of storage media that may be accessed by the device via the radio interface layer 872 or via a wired connection between the mobile computing device 800 and a separate computing device associated with the mobile computing device 800, for example, a server computer in a distributed computing network, such as the Internet. As should be appreciated such data/information may be accessed via the mobile computing device 800 via the radio interface layer 872 or via a distributed computing network. Similarly, such data/information may be readily transferred between computing devices for storage and use according to well-known data/information transfer and storage means, including electronic mail and collaborative data/information sharing systems.

Aspects of the present disclosure, for example, are described above with reference to block diagrams and/or operational illustrations of methods, systems, and computer program products according to aspects of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more aspects provided in this application are not intended to limit or restrict the scope of the disclosure as claimed in any way. The aspects, examples, and details provided in this application are considered sufficient to convey possession and enable others to make and use the best mode of claimed disclosure. The claimed disclosure should not be construed as being limited to any aspect, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

What is claimed is:

1. A method for performing a numerical simulation, the method comprising:
receiving input data expressed in at least a first domain;
decomposing the input data into at least i) low-pass filtered data that captures a low-pass filtered version of the input data in the at least the first domain and ii) high-pass filtered data that captures a high-pass filtered version of the input data in the at least the first domain;
transforming the low-pass filtered data to frequency domain;
applying a first set of weights to the low-pass filtered data in the frequency domain to generate weighted low-pass filtered data in the frequency domain;
transforming the weighted low-pass filtered data from the frequency domain to the at least the first domain; and
composing output data for the numerical simulation based on at least the weighted low-pass filtered data in the at least the first domain.

2. The method of claim 1, wherein:
decomposing the input data comprises applying a discrete wavelet transform (DWT) to the input data, and
composing the output data comprises applying an inverse discrete wavelet transform (IDWT) to at least the weighted low-pass filtered data in the at least the first domain.

3. The method of claim 1, wherein:
transforming the low-pass filtered data to the frequency domain comprises applying a discrete Fourier transform (DFT) to the low-pass filtered data, and
transforming the weighted low-pass filtered data from the frequency domain to the at least the first domain comprises applying an inverse discrete Fourier transform (IDFT) to the weighted low-pass filtered data.

4. The method of claim 1, wherein composing the output data for the numerical simulation comprises composing the output data based on i) the weighted low-pass filtered data in the at least the first domain and ii) the high-pass filtered data that captures the high-pass filtered version of the input data in the at least the first domain.

5. The method of claim 1, further comprising applying a second set of weights to the high-pass filtered data to generate weighted high-pass filtered data in the at least the first domain, wherein composing the output data for the numerical simulation comprises composing the output data on based on i) the weighted low-pass filtered data in the at least the first domain and ii) the weighted high-pass filtered data in the at least the first domain.

6. The method of claim 5, wherein applying the second set of weights to the high-pass filtered data comprises applying the second set of weights to a subset of high frequency coefficients in the high-pass filtered data, the subset including one or both of i) a subset of largest magnitude high frequency coefficients in the high-pass filtered data and ii) a subset of smallest magnitude high frequency coefficients in the high-pass filtered data.

7. The method of claim 1, wherein the input data is expressed in one or both of spatial domain and time domain.

8. The method of claim 1, wherein the numerical simulation models multi-phase flow of carbon dioxide (CO₂) in sub-surface at a CO₂ injection site.

9. The method of claim 8, wherein
the input data comprises one or more parameters of the CO₂ injection site, and
the output data comprises one or both of saturation and pressure distribution of CO₂ as a function of time as CO₂ injected into the CO₂ site propagates in the sub-surface at the CO₂ injection site.

10. A system comprising:
one or more computer readable storage media; and
program instructions stored on the one or more computer readable storage media that, when executed by at least one processor, cause the at least one processor to:
receive training data for training a neural network to perform numerical simulations to model a physical phenomenon, the training data determined based on a solution of one or more differential equations that model the physical phenomenon,
train a neural network, based on the training data, to perform numerical simulations modeling the physical phenomenon, wherein the neural network is configured to operate with decomposed data,
receive input data for a numerical simulation, the input data expressed in at least a first domain,
decompose the input data into at least i) low-pass filtered data that captures a low-pass filtered version of the input data in the at least the first domain and ii) high-pass filtered data that captures a high-pass filtered version of the input data in the at least the first domain,
transform the low-pass filtered data to frequency domain,
apply a first set of weights to the low-pass filtered data in the frequency domain to generate weighted low-pass filtered data in the frequency domain,
transform the weighted low-pass filtered data from the frequency domain to the at least the first domain, and
compose an output for the numerical simulation based on at least the weighted low-pass filtered data in the at least the first domain.

11. The system of claim 10, wherein the program instructions, when executed by the at least one processor, cause the at least one processor to
decompose the input data at least by applying a discrete wavelet transform (DWT) to the input data, and
compose the output data at least by applying an inverse discrete wavelet transform (IDWT) to at least the weighted low-pass filtered data in the at least the first domain.

12. The system of claim 10, wherein the program instructions, when executed by the at least one processor, cause the at least one processor to
transform the low-pass filtered data to the frequency domain at least by applying a discrete Fourier transform (DFT) to the low-pass filtered data, and
transform the weighted low-pass filtered data from the frequency domain to the at least the first domain at least by applying an inverse discrete Fourier transform (IDFT) to the weighted low-pass filtered data.

13. The system of claim 10, wherein the program instructions, when executed by the at least one processor, cause the at least one processor to compose the output data of the numerical simulation data based on i) the weighted low-pass filtered data in the at least the first domain and ii) the high-pass filtered data that captures the high-pass filtered version of the input data in the at least the first domain.

14. The system of claim 10, wherein the program instructions, when executed by the at least one processor, further cause the at least one processor to
apply a second set of weights to the high-pass filtered data to generate weighted high-pass filtered data in the at least the first domain, and
compose the output data for the numerical simulation based on i) the weighted low-pass filtered data in the at least the first domain and ii) the weighted high-pass filtered data in the at least the first domain.

15. The system of claim 14, wherein the program instructions, when executed by the at least one processor, cause the at least one processor to apply the second set of weights to a subset of high frequency coefficients in the high-pass filtered data, the subset including one or both of i) a subset of largest magnitude high frequency coefficients in the high-pass filtered data and ii) a subset of smallest magnitude high frequency coefficients in the high-pass filtered data.

16. The system of claim 10, wherein the input data is expressed in one or both of spatial domain and time domain.

17. The system of claim 10, wherein
the numerical simulation models multi-phase flow of carbon dioxide (CO₂) in sub-surface at a CO₂ injection site,
the input data comprises one or more parameters of the CO₂ injection site, and
the output data comprises one or both of saturation and pressure distribution of CO₂ as a function of time as CO₂ injected into the CO₂ site propagates in the sub-surface at the CO₂ injection site.

18. A computer-readable storage medium storing computer-executable instructions that when executed by at least one processor cause a computer system to:
receive input data for a numerical simulation, the input data expressed in at least a first domain,
decompose the input data into at least i) low-pass filtered data that captures a low-pass filtered version of the input data in the at least the first domain and ii) high-pass filtered data that captures a high-pass filtered version of the input data in the at least the first domain,
transform only the low-pass filtered data to frequency domain,
apply a first set of weights to the low-pass filtered data in the frequency domain to generate weighted low-pass filtered data in the frequency domain,
transform the weighted low-pass filtered data from the frequency domain to the at least the first domain, and
compose an output for the numerical simulation based on at least the low-pass filtered data in the at least the first domain.

19. The computer-readable storage medium of claim 18, wherein the instructions, when executed by the at least one processor, cause the computer system to
decompose the input data at least by applying a discrete wavelet transform (DWT) to the input data, and
compose the output data at least by applying an inverse discrete wavelet transform (IDWT) to at least the weighted low-pass filtered data in the at least the first domain.

20. The computer-readable storage medium of claim 16, wherein the instructions, when executed by the at least one processor, cause the computer system to
transform the low-pass filtered data to the frequency domain at least by applying a discrete Fourier transform (DFT) to the low-pass filtered data, and
transform the weighted low-pass filtered data from the frequency domain to the at least the first domain at least by applying an inverse discrete Fourier transform (IDFT) to the weighted low-pass filtered data.
